(19) United States
(12) Patent Application Publication
(10) Pub. No.: US 2007/0209764 A1
(43) Pub. Date: Sep. 13, 2007

(54) Fire-alarm-controlled roller shutter

(76) Inventor: Hans Arnhold, Alzenau (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/708,867

(22) Filed: Feb. 21, 2007

(30) Foreign Application Priority Data
Feb. 23, 2006 (DE) 102006008314.8-42

(51) Int. Cl. E05F 15/20

(52) U.S. Cl. 160/7

(57) ABSTRACT

A safety device is provided that includes a roller shutter and a fire alarm. A communications connection is provided between the fire alarm and the roller shutter. When the fire alarm detects the presence of a fire, a corresponding signal is transmitted to the roller shutter via the communications connection. The roller shutter is then opened.

### BACKGROUND OF THE INVENTION

Automatically actuated roller shutters have become fairly common. Two different types systems have generally been used. In older systems, a tubular motor is arranged in a wind-up shaft of the roller shutter in order to drive the wind-up shaft for winding or unwinding the roller-shutter curtain from the roller-shutter shaft. The tubular motor is a self-locking geared motor operated with network voltage. Without power, the roller shutter can be neither opened nor closed.

In the other system, the roller-shutter shaft is activated by a roller-shutter belt that is coupled to an electrical drive system. The drive system can be either a frictional system that helps transport the roller-shutter belt in a direction towards a spring-biased winding mechanism or the motor itself can drive a belt pulley to which the roller-shutter belt is anchored on one end.

With the systems driven a roller-shutter belt, it can be difficult to open the roller shutter if the power is lost. The roller shutter can be opened by pulling on the roller-shutter belt, but the roller shutter is held in position only as long as the user actually holds the roller-shutter belt. When the user lets go of the belt, the roller-shutter curtain immediately falls back down.

If a fire breaks out in a residence or a house, it is often necessary to maintain access to the residence or house via the windows. In such a case, closed roller shutters can be a dangerous obstacle that makes access for the fire department more difficult and blocks possible escape paths for the people inside the building.

### BRIEF SUMMARY OF THE INVENTION

In view of the foregoing, an object of the invention is creating a system or components that help prevent closed roller-shutter curtains from becoming an unwanted obstacle in the event of a fire. To this end, the novel safety system of the present invention includes a roller-shutter curtain that can be wound onto a roller-shutter shaft. The roller-shutter shaft is rotated for both letting down (i.e. closing) the roller-shutter curtain from and winding (i.e., opening) the roller-shutter curtain onto the wind-up shaft by a drive motor that draws its energy from the power network. A control device is allocated to the drive motor. The control device can actuate the drive motor based on either a command from a user or a time-controlled process.

The control device includes a receiving device for receiving control signals, in particular control signals from a fire alarm that is part of the safety system. The fire alarm can be any type of alarm device that can identify the presence of a fire, for example, a smoke detector, temperature monitor or flame detector. The fire alarm can include a transmitting device for transmitting signals that are characteristic of a fire to the receiving device of the control device.

According to the invention, the control device and fire alarm can be operated in such a way that the control device actuates the drive motor when a fire is detected by the fire alarm and the corresponding signals are transmitted. Upon actuation, the drive motor rotates the wind-up shaft so as to wind the roller-shutter curtain onto the wind-up shaft (i.e., in the wind-up direction). Thus, the safety system of the present invention ensures that even the windows that were previously closed by a roller-shutter curtain are freely accessible. This aspect of the safety system is based on the consideration that at the beginning of a fire, when the fire alarm responds, the power supply in the house or the residence will still function with sufficient reliability to set the relevant motors in gear automatically.

According to the conditions in the particular residence or house, several fire alarms can be installed in different rooms and the system can configured so that when one of the fire alarms detects a fire the system opens not only the roller shutters in the room in which a responding fire alarm is located but also all of the other roller shutters in the residence or house.

Any type of known roller-shutter curtain can be used, for example, roller-shutter curtains made from metallic segments.

If a tubular motor is used as the drive motor, the roller-shutter shaft preferably has a tubular configuration in order to house the drive motor directly therein. Because they provide a high driving power, tubular motors have the advantage of opening the roller shutters relatively quickly. When a tubular motor is used, the motor is preferably powered directly with network voltage.

The present invention also can be used with roller shutters actuated by a belt. In such cases, the roller-shutter shaft, regardless of whether it is solid or tubular, is locked in rotation with a belt pulley. The roller-shutter belt has one end fixed to and can be wound onto the belt pulley. The drive motor is offset from the roller-shutter shaft and is arranged to move the roller-shutter belt.

There are at least two different ways in which to drive the roller-shutter belt. The drive motor can drive one or more friction rollers via a gear. The friction rollers, in turn, can take along the roller-shutter belt via frictional engagement. The roller-shutter belt is wound onto the base of a spring motor with a wind-up machine. Alternatively, the drive motor can be coupled with a belt pulley to which the other end of the roller-shutter belt is fixed.

The drive motors for moving the roller-shutter belt are preferably motors that can be powered with emergency low voltage because of their small size and ability to be retrofit.

The communication between the fire alarm and the control device for the drive motor can be wireless or wired. A wireless arrangement has the advantage that it can be easily retrofitted without great installation expense. A wired arrangement has the advantage that it is less susceptible to noise.

As noted, any known type of fire alarm is suitable for use with the present invention including fire alarms that utilize the scattering of light through smoke, those that respond to the change in ionization due to smoke in an ionization chamber, those that respond to temperature, and those that operate by means of infrared.

To allow for the simplest installation or retrofitting, the fire alarm advantageously can be battery-powered. For increasing the service life of the battery, a photocell arrangement can be provided in order to obtain the necessary energy from sunlight during the day.

Preferred embodiments of the invention are described herein in order to illustrate the basic principles of the present invention. It is understood that the present invention encompasses, inter alia, variations or modifications of the preferred embodiments that are made in order to adapt the present invention to particular conditions.

### BRIEF DESCRIPTION OF THE SEVERAL VIEWS OF THE DRAWINGS

FIG. 1 is a perspective schematic view of an exemplary belt driven roller shutter and associated fire alarm in accordance with present invention.

FIG. 2 is a schematic diagram showing the principle electromechanical and electronic construction of the arrangement of FIG. 1.

FIG. 3 is a perspective view of the drive of the roller-shutter belt of FIG. 1 using a motor-driven belt pulley.

FIG. 4 is a perspective view of a roller-shutter according to the invention driven by a tubular motor.

### DETAILED DESCRIPTION OF THE INVENTION

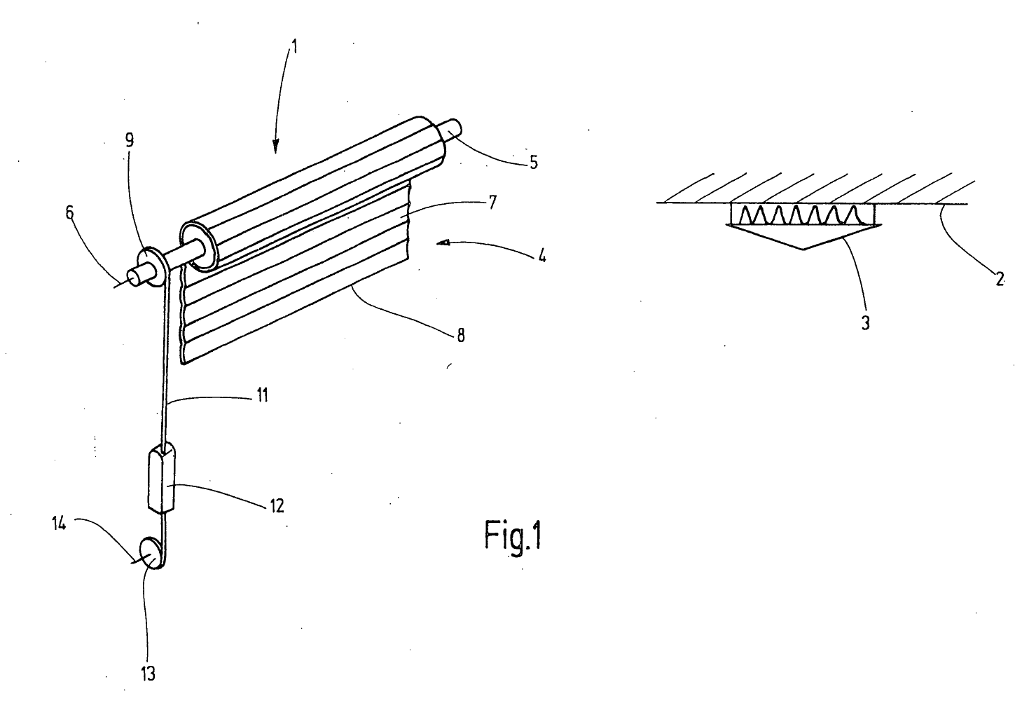

Referring to FIG. 1 of the drawings, an illustrative safety system according to the invention is shown. The illustrated safety system includes a roller shutter 1 and a fire or smoke alarm 3 mounted underneath a ceiling 2. The roller shutter 1 includes a roller-shutter curtain 4 that can be wound onto a roller-shutter shaft 5. The roller-shutter shaft 5 has bearing journals 6 that help rotatably support the roller-shutter shaft 5 above a window of a building window, for example, below the window lintel.

The roller-shutter curtain 4 is assembled from individual segments 7 that can move relative to each other. The roller-shutter curtain 4 has a first edge fixed to the roller-shutter shaft 5 and a second edge that forms a bottom edge 8 which can move up and down in front of the window with its downward movement being limited by a window apron.

A roller-shutter belt 11 has one end anchored to a belt pulley 9. The belt pulley is locked in rotation with the roller-shutter shaft 5. The roller-shutter belt 11 leads through a drive device 12 and from there to a winding pulley 13 that is rotatably supported by an axle 14. The winding pulley 13 is arranged in a wall pocket in a known manner and is pretensioned in the winding up direction of the roller-shutter belt 11 by a spring motor in the form of a clockwork spring. The drive device 12 includes the necessary electronics for operating the roller shutter.

In the illustrated embodiment, the fire alarm 3 is located on the ceiling 2 in an appropriate position in the same room as the window with the roller shutter 1, or alternatively in a different room. The fire alarm 3 can be any type of fire alarm that detects a change in the physical state of the air when the air contains smoke or combustion gases. Because the specific type of fire alarm 3 is not the subject matter of the invention, it is not described in further detail herein.

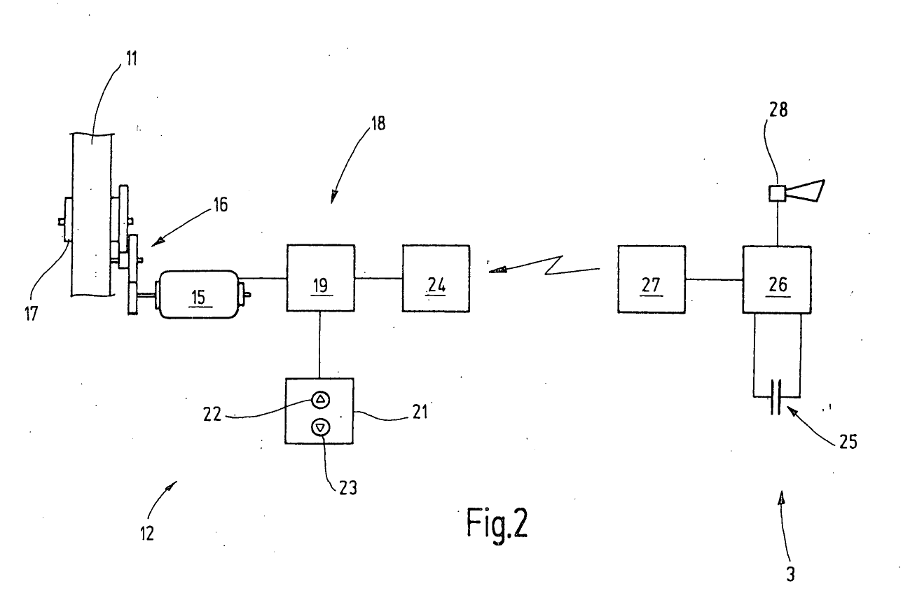

The construction of the various modules that can be used to provide interaction between the fire alarm 3 and the roller shutter 1 are shown in FIG. 2. A drive motor 15 is provided in the housing of the drive device 12. In this case, the drive motor operates with an emergency low voltage and drives a friction roller 17 (or several) via positive-fit gearing 16. A wraparound angle that is sufficient for generating adequate frictional entrainment between the friction roller 17 and the roller-shutter belt 11 is ensured through the use of deflection and dancing rollers.

The motor 16 is connected to a control device 18 that has a central control part 19. The central control part 19 generates the necessary low voltage from the network voltage and can be used for detecting physical end positions of the roller-shutter curtain 4. The control part 19 ensures that the roller-shutter curtain 4 is moved only between these physical end positions. The central control part 19 can also include a clock device for directing up and down movement of the roller-shutter curtain 4 based on the time. The central control part 19 can also facilitate control of user-specific functions, such as sun protection and the like. A keyboard 21 with keys 22 and 23 can be connected to the central control part 19 to enable a user to directly control the opening and closing of the roller shutter 1. This keyboard 21 could also be used for programming.

A receiving device 24 that can act as a communication interface for the drive device 12 can be connected to the central control part 19. The drive device 12 can obtain a signal via the receiving device 24 which directs actuation of the drive motor 15 to open the roller shutter 1. The receiving device 24 can operates at any desired frequency such a frequency approved and license-free for comparable applications in the household sector.

In the illustrated embodiment, the fire alarm 3 comprises an ionization fire alarm that includes an ionization chamber 25 that is connected to evaluation electronics 26. The evaluation electronics 26 are, in turn, connected to a transmitting device 27 that also represents a communications device. The transmitting device 27 operates at the same frequency and with the same coding as the receiving device 24 so that a signal can be transmitted wirelessly from the fire alarm 3 to the drive device 12 in a substantially noise-free manner. In this case, another acoustic signal generator 28 is also connected to the evaluation electronics 26.

The illustrative safety system operates as follows. In normal operation, the central control part 19 controls movement of the roller shutter 1 (i.e., actuates the motor) based on the time. The receiving device 24 is in constant operation and thus is ready at any time to receive a corresponding signal. The fire alarm 3, which can be located in the same room or in a different room, continuously monitors the air in its respective room for the presence of combustion gases or smoke or smoke aerosol in a known manner. As long as such gases do not appear in the ionization chamber 25, the fire alarm 3 does not generate a signal via the signal horn 28. Likewise, the transmitting device 27 does not emit a signal that would indicate an alarm state.

The monitoring of the air in the surroundings of the fire alarm 3 is performed continuously. Here, if states should occur in the ionization chamber 25 that point to a fire, this is detected by the evaluation electronics 26. The evaluation electronics 26 then immediately trigger the signal horn 28 in order to output an acoustic alarm. In addition, a signal is transmitted by the evaluation electronics 26 via the transmit device in a wireless way to the receive device 24 of the drive device 12. This signal is evaluated in the central control part 19. The central control device 19 ensures that the drive motor 15 is set in gear immediately in the sense of opening the roller shutter 1.

The radio path between the control device and the fire alarm 3 can be made sufficiently secure through known coding techniques to prevent outside fire alarms or other systems that operate on a similar or the same frequency from improperly actuating the control device 12. Such coding techniques are known and any desired variant can be selected that achieves the desired function.

Those skilled in the art will appreciate that the connection between the fire alarm 3 and the drive device 12 also can be wired. Additionally, the communications path between the two units can be monitored continuously to determine whether it is functioning properly so that when the communications connection is broken an alarm signal can be produced. To this end, the drive device 12 also can be equipped with an alarm device. The communications connection between the drive device 12 and the fire alarm 3 preferably can have a bidirectional construction so that these units can selectively control each other.

Of course, the roller shutter 1 can be controlled via several fire alarms 3 that are positioned at different locations in the room or in different rooms of the same building. Additionally, more than one roller shutter, for example, several or all the roller shutters in a building can be controlled via one or more fire alarms 3 so as to open all of the roller shutters automatically in the case of a fire.

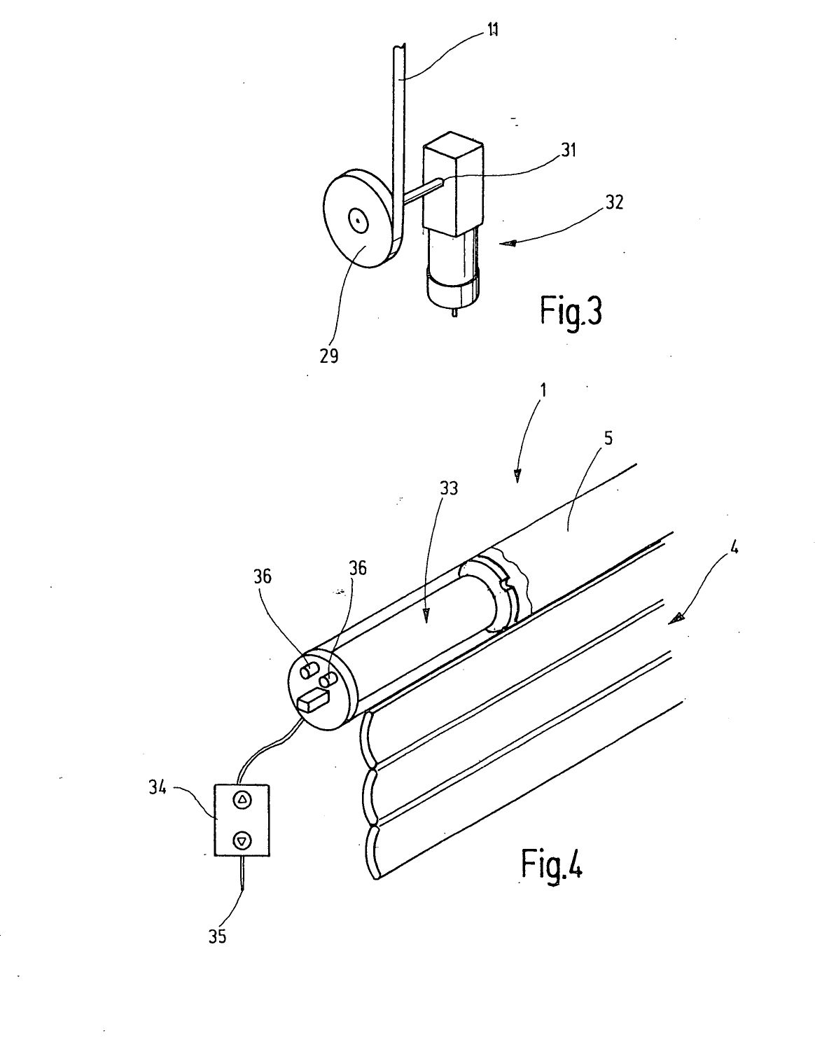

The present invention is not limited to roller-shutter drives in which the roller-shutter belt is driven by means of a friction carrier. An arrangement using a roller-shutter belt 11 that is wound onto a belt pulley 29 is shown in FIG. 3. The belt pulley 29 sits on an output shaft 31 of a geared motor 32. The geared motor 32 can be controlled in the same way as the motor 15 from a central control unit 19. The geared motor 32 can be configured to operate at an emergency low voltage between 12 and 48 volts.

An embodiment of the invention in which the roller shutter 1 has a tubular wind-up shaft 5 to which on edge the roller-shutter curtain 4 is fixed is shown in FIG. 4. A tubular motor 33 is arranged in the interior of the tubular wind-up shaft 5. The tubular motor 33 is connected to a control device 34 that receives its power-supply voltage via a network line 35.

Additional setting elements 36 that help adjust end switches that define the end positions of the roller-shutter curtain 4 are provided on the tubular motor 33. The control device 34 can be constructed in generally the same way as the control device 18 of FIG. 2 at least with respect to the communications between the control device 34 and one or more fire alarms 3.

Based on the foregoing, the present invention provides a safety device that includes a roller shutter and a fire alarm. A communication connection is provided between the fire alarm and the roller shutter. As soon as the fire alarm detects the presence of a fire, a corresponding signal is transmitted to the roller shutter via the communications connection and the roller shutter is then opened.

1. A safety system comprising:
a roller-shutter curtain that is windable onto a roller-shutter shaft;
a drive motor for the roller-shutter shaft;
a control device for controlling operation of the drive motor;
a receiving device associated with the control device for receiving a control signal;
a fire alarm; and
a transmitting device for transmitting a control signal that is characteristic of a detected fire to the receiving device when the fire alarm detects a fire and wherein upon receipt of the control signal the control device actuates the drive motor to wind the roller-shutter curtain onto the roller-shutter shaft.

2. A safety system according to claim 1 wherein the roller-shutter curtain includes a plurality of metallic segments.

3. A safety system according to claim 1 wherein the roller-shutter shaft has a tubular construction.

4. A safety system according to claim 1 wherein the drive motor is arranged adjacent the roller-shutter shaft (5).

5. A safety system according to claim 1 wherein the drive motor comprises a a geared motor arranged in the roller-shutter shaft.

6. A safety system according to claim 1 wherein the drive motor is operable via network voltage.

7. A safety system according to claim 1 wherein a belt pulley is locked in rotation with the roller-shutter shaft and an end of a roller-shutter belt is connected to the belt pulley and is windable on the belt pulley.

8. A safety system according to claim 7 wherein the drive motor is arranged to move the roller-shutter belt.

9. A safety system according to claim 8 wherein the drive motor drives at least one friction roller that interacts with the roller-shutter belt by means of frictional engagement.

10. A safety system according to claim 8 wherein the drive motor is drivably engaged to a belt pulley to which an end of the roller-shutter belt is fixed.

11. A safety system according to claim 1 wherein the drive motor is operable via an emergency low voltage.

12. A safety system according to claim 1 wherein the control device includes a clock device for directing movement of the roller-shutter shaft (5).

13. A safety system according to claim 1 wherein the receiving device includes a wireless communications interface.

14. A safety system according to claim 1 wherein the receiving device has a wired communications interface.

15. A safety system according to claim 1 wherein the fire alarm is configured to detect temperature or smoke.

16. A safety system according to claim 1 wherein the transmitting device and the receiving device operate at the same frequency.

17. A safety system according to claim 16 wherein the receiving device and the transmitting device communicate wirelessly.

18. A safety system according to claim 16 wherein the receiving device and transmitting device communicate via one or more wires.

19. A safety system according to claim 1 wherein the fire alarm is battery-powered.

20. A safety system according to claim 1 wherein the fire alarm includes a plurality of photocells for supplying power.

21. A control device for the drive motor of a roller shutter comprising a communications interface for receiving a signal from a fire alarm.

22. A drive device for a roller shutter comprising a drive motor and a control device for the drive motor, wherein the control device includes a communications interface for receiving a signal from a fire alarm.

23. A fire alarm comprising a communications device for directing a fire-alarm signal to a control device for a roller shutter.
